(19) United States
(12) Patent Application Publication
(10) Pub. No.: US 2010/0009729 A1
(43) Pub. Date: Jan. 14, 2010

(54) Slide-tilt mechanism for an electronic device

(76) Inventor: Esa-Sakari Maatta, Viiala (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/308,969

(22) PCT Filed: Jun. 28, 2006
(86) PCT No.: PCT/EP2006/006305

§ 371 Date: Apr. 22, 2009

(51) Int. Cl. H04M 1/00

(52) U.S. Cl. 455/575.4

(57) ABSTRACT

A slide-tilt mechanism for an electronic device comprising a first part and a second part, the first part being connected to the second part such that in a first mode, the second part is axially slideable relative to the first part between a first position and a second position, and in a second mode the second part is moveable relative to the first part between the second position and a third, tilted position; the slide-tilt mechanism further comprising a first biasing mechanism arranged to bias the second part from the second position towards the third tilted position.

### FIELD OF THE INVENTION

This invention relates to a slide-tilt mechanism, and to an electronic device incorporating such a slide-tilt mechanism. The invention relates particularly to a slide-tilt mechanism for use in a portable electronic device (which may or may not be hand-held in use), although the slide-tilt mechanism of the invention may also be used in non-portable electronic devices. The invention also relates to slide-tilt mechanisms for use with mobile radiotelephones. Embodiments of the invention need not have radiotelephone functionality and may include one or more of computer game playing functionality, music playing/recording functionality (e.g. MP3 or other music format), image playing/recording functionality (still/video images).

### BACKGROUND

There is currently a high demand for compact mobile telephones. In order to reduce the size of mobile telephones, it is known to include a mechanism in the telephone that enables the telephone to be converted from a closed configuration to an open configuration.

It is known to use a sliding mechanism to allow two parts of a mobile telephone to slide over one another. The action of opening the telephone may expose a key pad and/or a screen thus serving the function of preventing inadvertent operation when closed, as well as reducing the size of the overall device.

It is further known to include a tilt mechanism in conjunction with a sliding mechanism to allow, for example a display screen of an electronic device to tilt relative to a keypad when the electronic device is in an open configuration. It may be ergonomically desirable to be able to tilt a display screen in this way. For example, if the electronic device comprises a laptop computer, or mobile telephone which is positioned on a desk for use in a conference, it may be desirable for the display screen to be tilted relative to the key pad.

### OBJECT OF THE INVENTION

An object of the present invention is to provide a slide-tilt mechanism for an electronic device, including a slide-tilt mechanism for a mobile radiotelephone.

### SUMMARY OF THE INVENTION

According to a first aspect of the present invention there is provided a slide-tilt mechanism for an electronic device comprising a first part and a second part, the first part being connected to the second part such that in a first mode, the second part is axially slideable relative to the first part between a first position and a second position, and in a second mode the second part is moveable relative to the first part between the second position and a third, tilted position, the slide-tilt mechanism further comprising a first biasing mechanism arranged to bias the second part from the second position towards the third tilted position.

By means of the first biasing mechanism, when the second part is in its second position, it is tiltable relative to the first housing and therefore will move towards the third, tilted position with little or no force needing to be applied by a user.

By means of the present invention, in one embodiment, an electronic device, such a mobile radiotelephone may be readily moved from a closed configuration to an open configuration. In the open configuration, the second part is able to tilt relative to the first part such that a display panel or some other user interface (for user input and/or user output) formed on a front face of the second part may be positioned at an angle relative to the first part. A further user interface (which may be for user input and/or user output) which may be formed on a front face of the first part may also be exposed when the device is in the tilted configuration.

According to a second aspect of the present invention there is provided an electronic device having a first housing and a second housing, and further comprising a slide-tilt mechanism for an electronic device comprising a first part and a second part, the first part being connected to the second part such that in a first mode, the second part is axially slideable relative to the first part between a first position and a second position, and in a second mode the second part is moveable relative to the first part between the second position and a third, tilted position:
the slide-tilt mechanism further comprising a first biasing mechanism arranged to bias the second part from the second position towards the third tilted position.

Preferably the first and second housings of the electronic device according to the second aspect of the invention comprise the first and second parts respectively of the slide-tilt mechanism according to the first aspect of the present invention.

Preferably, the first part comprises an engine cover having a key pad formed on a front face thereof, and the second part comprises a display cover having a display screen formed on a front face thereof.

When the second part is in its first position, the electronic device is in a closed configuration in which the front face of the first part is substantially covered by the second part.

When the second part is in its second or third positions, the electronic device is in an open configuration in which the front face of the first part is substantially exposed.

When the second part moves in the first mode, the first and second parts may be substantially parallel to one another.

The slide-tilt mechanism may further comprise a second biasing mechansim for biasing the second part away from its first position, towards its second position.

This means that if a user wishes to open the electronic device the user merely has to push the second part towards it second position. Thereafter, the second biasing mechanism will cause the second part to continue to move away from the first position towards the second position.

Advantageously, the slide-tilt mechanism further comprises a lock mechanism. The lock mechanism may restrict movement of the second part to axial movement when the second part is moving between the first and second positions, and may restrict movement of the second part to tilting movement when the second part is moving between the second and third positions.

The lock mechanism may be formed separately to the first biasing mechanism, or it may be formed integrally with the first biasing mechanisms.

Conveniently, the lock mechanism may have a first state in which the second part is moveable only in the first mode, and a second state in which the second part is moveable only in the second mode.

The lock mechanism may comprise an intermediate state in which the second part is movable in both the first and the second modes. In other words, the lock comprises an intermediate state in which both axial and tilting movement of the second part may take place.

In such an embodiment the lock mechanism begins to move into its intermediate state, between its first and second states when the second part is at its second position. Whilst the lock mechanism is in its intermediate state, the second part may move both axially and in a tilting manner as it moves from its second position to its third position. In other words, in such an embodiment, when the lock mechanism is in its intermediate state, the second part may move in both the first and the second modes.

In one embodiment, the lock mechanism may be moveable between the first and second states only when the second part is in its second position.

Advantageously, the slide-tilt mechanism may further comprise a connector for connecting the first part to the second part, which connector is operatively connected to the lock mechanism.

Conveniently, both the second part and the connector are pivotally moveable relative to the first part when the lock mechanism is in its second state. The connector thus moves with the second part when the second part moves from the second position to the third position.

When the lock mechanism is in its second state, therefore, the connector is pivotally moveable, and this pivotal movement causes a corresponding pivotal movement of the second part relative to the first part.

Preferably, the connector has a first end portion connected to the second part, and an opposite, second end portion pivotally connected to the first part.

Advantageously, the lock mechanism may comprise a third state in which the second part is held in its third, tilted, position.

This means that once the second part has moved to its third, tilted position, it will be held in that position by the lock mechanism without a user having to take any action to hold the position of the second housing in the tilted position.

Advantageously, the first biasing mechanism comprises a resilient member operatively connected to the lock mechanism. The resilient member may take any convenient form and may for example be in the form of a first spring mounted on a pin formed in the first part.

Conveniently, the connector and the lock mechanism may both be pivotable about the pin. This means that when the lock mechanism is in its second state, the connector, the lock mechanism and the second part are all pivotally moveable relative to the first part.

Advantageously, the lock mechanism may comprise a lock lever, and a latch engagable with the lock lever to hold the lock mechanism in its first state.

The latch may be formed integrally with the first part, or may be formed separately thereto.

The lock lever preferably comprises a first lever portion positioned within the first part, a second lever portion extending at least partially over a front face of the first part, and a bearing surface, the latch being held between the second lever portion and the bearing surface when the lock mechanism is in its first state.

The slide-tilt mechanism may further comprise a latch disengager for disengaging the latch from the lock lever when the second part is at its second position. Once the latch has been disengaged, the lock mechanism is free to move from its first state to its second state. In some embodiments, the lock mechanism moves from its first state, to its second state via its intermediate state.

The first biasing mechanism may cause the lock mechanism to move from its first state towards its second state once the latch is disengaged from the lock lever.

The latch disengager may be integrally formed with the second part, although it could also be separately formed from the second part.

Advantageously, the latch disengager comprises an end portion of the second part.

In certain embodiments of the invention comprising a second biasing mechanism, the second part will move towards its second position due to the force exerted on it by the second biasing mechanism. Once the second part reaches its second position, the end portion of the second part will abut with the latch. The kinetic energy of the second part will cause the end portion of the lock lever to disengage with the latch thus releasing the lock mechanism. The first biasing mechanism will then move the lock mechanism to its second state, and hence the second part, to its third, tilted position.

Advantageously, the latch is engagable with the lock lever to hold the lock mechanism in its third state. The latch thus serves to hold the lock mechanism, and therefore the second part, in the third, tilted position when a user requires the second part to be tilted relative to the first part. This means that, for example, once the second part has reached it third, tilted, position it will be held in that position by the lock mechanism and it will not be necessary for a user to support the second part in the tilted position.

In one embodiment, if a user wishes to use the electronic device in an open state, and with the first and second parts substantially parallel to one another, the user merely pushes down on the second part. This pushes the latch out of engagement with the lock lever, and allows the user to push the second part into its second position. At this point, the latch re-engages with the lock lever to latch the lock mechanism in its first state. The user may then use, or continue to use the electronic device. The second part will then be held in its second position, with no further tilting action possible. This is because, the force of the first biasing mechanism is greater than the force in the second biasing mechanism when the second part is in its second position.

One or more aspects and/or embodiments and/or features of one or more aspects and/or embodiments in one or more various combinations or in isolation are within the present disclosure whether or not specifically stated or claimed in isolation or that combination. Corresponding means for performing one or more of the functions described herein are also within the present disclosure. Methods of assembling devices and mechanisms described are within the present disclosure.

### BRIEF DESCRIPTION OF FIGURES

The invention will now be further described by way of example only with reference to the accompanying drawings in which:

FIG. 1 is a schematic representation of a first embodiment of slide-tilt mechanism according to the first aspect of the present invention for slideably connecting a first part to a second part forming part of an electronic device according to the second aspect of the present invention;

FIG. 2 is a detailed schematic representation of the slide-tilt mechanism of FIG. 1 showing the second part in its first position;

FIG. 3 is a detailed view of the lock mechanism forming part of the slide-tilt mechanism of FIG. 2;

FIG. 4 is a schematic representation of the slide-tilt mechanism of FIG. 2 showing the second part in its second position;

FIG. 5 is a schematic representation of the slide-tilt mechanism of FIG. 2 showing the lock mechanism in its intermediate state in its second position;

FIG. 6 is a schematic representation of the slide-tilt mechanism of FIG. 2 showing the second part in its third position;

FIG. 7 is a schematic representation of an electronic device incorporating the slide mechanism of FIGS. 1 to 6; and

FIG. 8 is a schematic representation of a second embodiment of a slide-tilt mechanism according to the first aspect of the present invention.

### SPECIFIC EMBODIMENTS

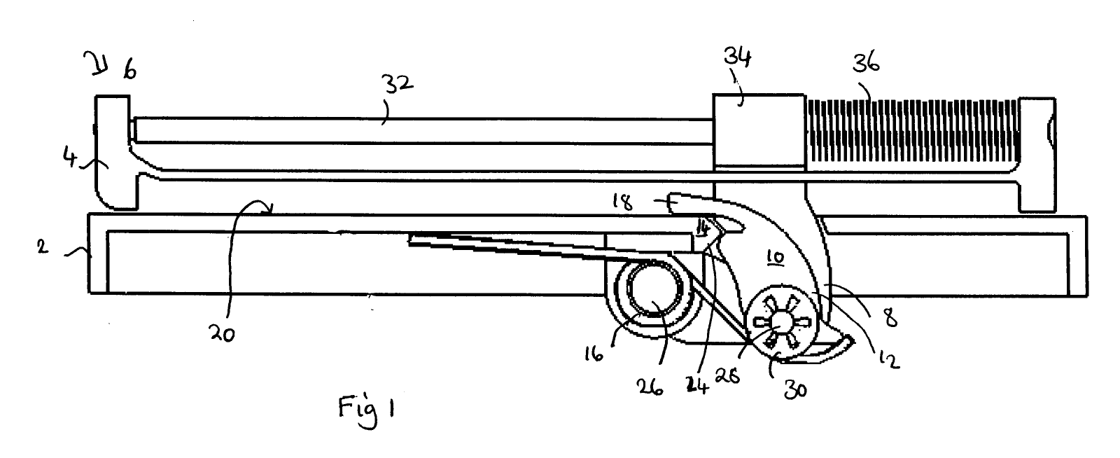

Referring to the FIGS. 1 to 6, a slide-tilt mechanism for an electronic device is designated generally by the reference numeral 6. The electronic device shown partially in the figures comprises a first housing 2 and a second housing 4. In the illustrated embodiment, the first housing 2 comprises an engine cover having a front face 20 on which is formed a keypad (not shown). The second housing 4 comprises a display housing or cover having a front face (not shown) in the form of a display.

When the first and second housings 2, 4 are in the position shown in FIG. 1, the second housing 4 is in its first position and the electronic device is in a closed configuration. In this configuration the keypad formed on the front face of the first housing 2 will be substantially covered by the second housing 4.

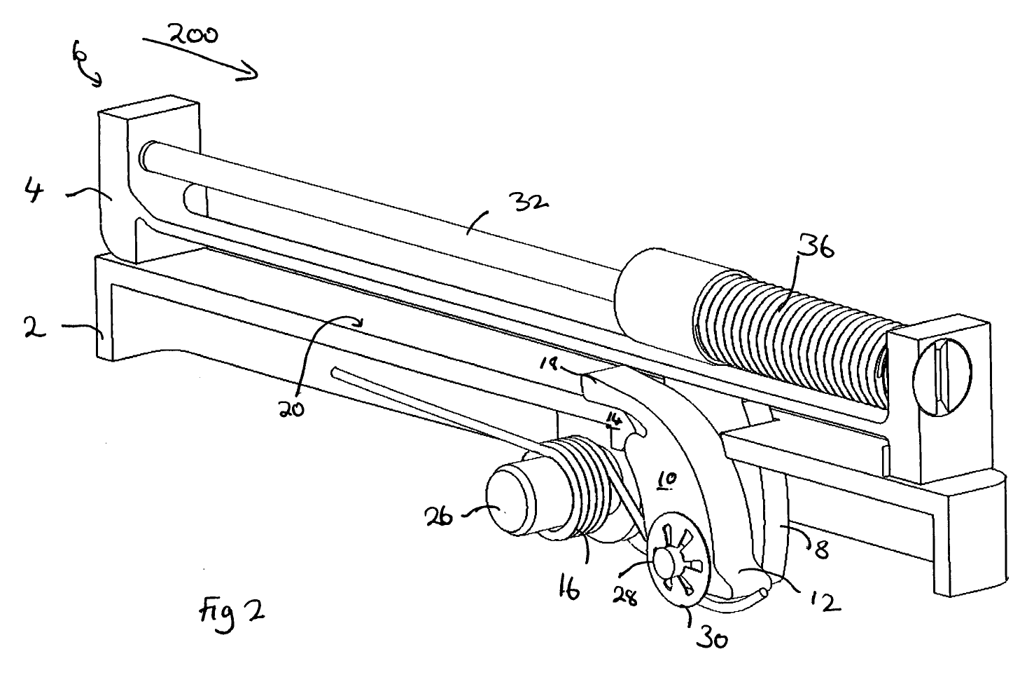

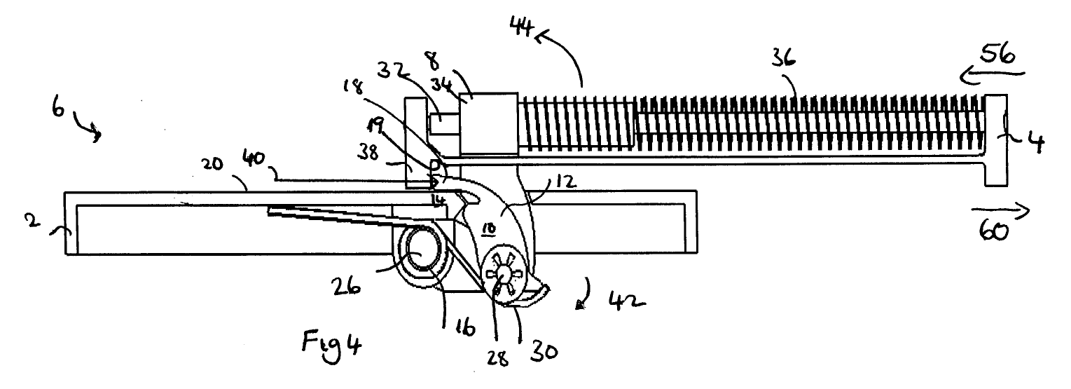

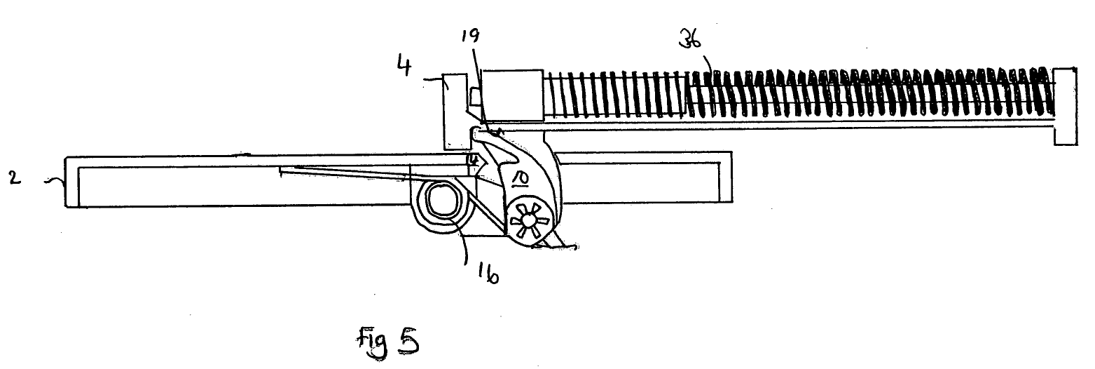

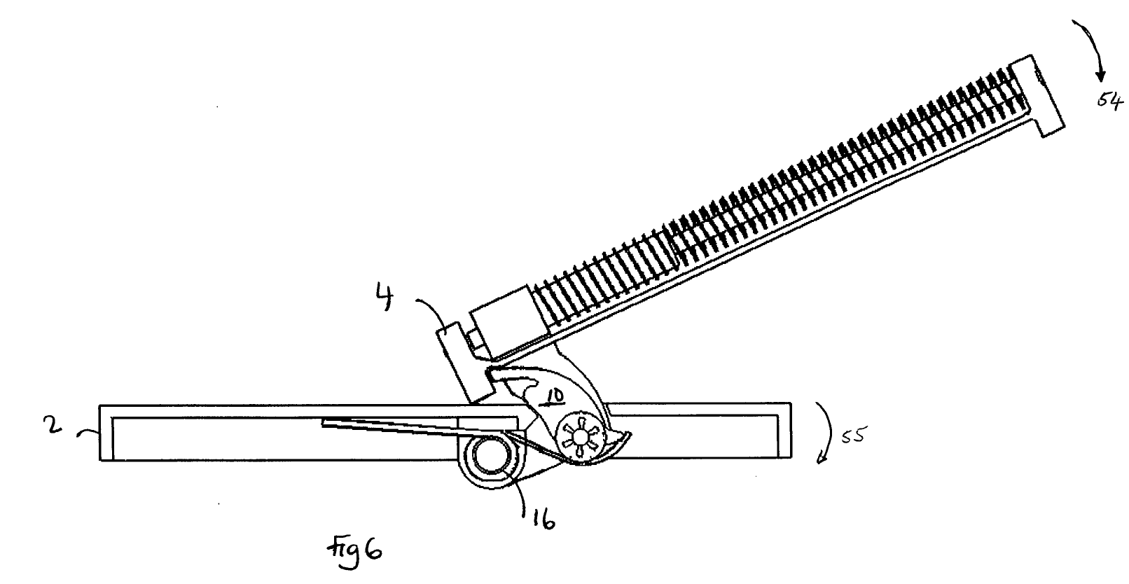

The slide-tilt mechanism 6 comprises a connector 8 connecting the first housing 2 to the second housing 4, and a lock mechanism 10 operatively connected to the connector 8. The lock mechanism 10 comprises a lock lever 12, a latch 14 and a spring 16. The spring 16 is mounted on a pin 26. The second housing 4 is moveable between a first position shown in FIGS. 1 and 2, a second position shown in FIG. 4, an extended position shown in FIG. 5, and a third position shown in FIG. 6. The spring 16 biases the second housing 4 towards its third position.

The lock lever 12 is positioned partially within the first housing 2, and has a portion 18 that extends outside of the first housing 2 and further extends, at least partially, over the front face 20 of the first housing 2. The portion of the first housing over which the extending portion 18 lies, forms the latch 14. In this embodiment of the invention the latch 14 is formed integrally with the first housing 2, although it could be separately formed.

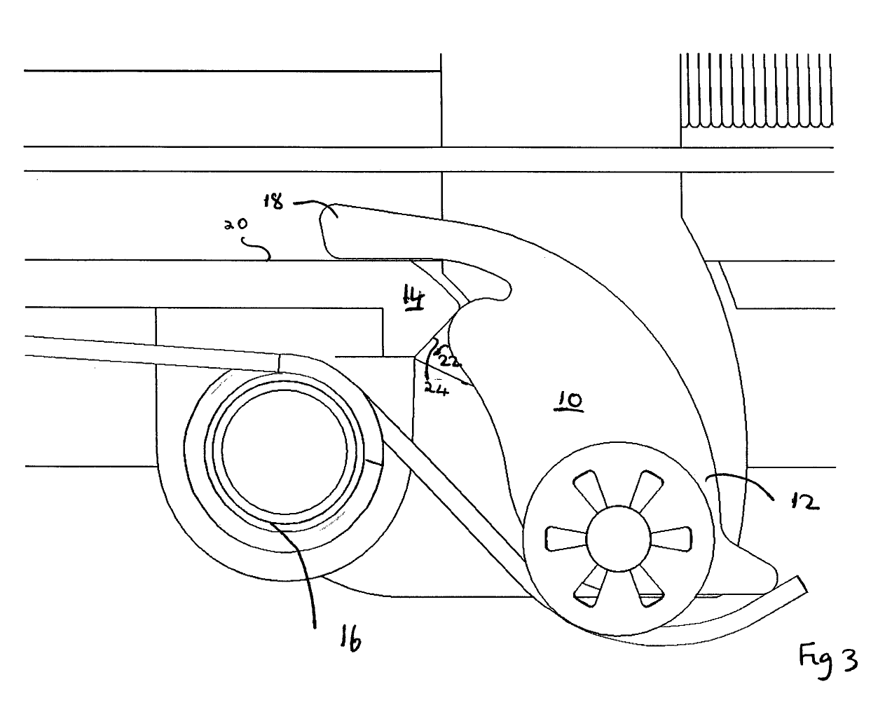

As can be seen particularly in FIG. 3, the lock lever 12 further comprises a bearing surface 22, which in this embodiment is in the form of cam surface. The latch 14 comprises a first surface 24 which bears down on the bearing surface 22 when the second housing 4 is in the first position as shown in FIG. 2.

The spring 16 biases the second housing 4 towards its third position. The lock lever 12 prevents this action, due to the engagement between the bearing surface 22 of the lock lever 12 and the surface 24 of the latch 14. This engagement is caused by the spring 16 which biases the lock lever 12 towards its first state (as shown in FIG. 2) against the latch 14. Disengagement of the surfaces 22/24 allows the spring 16 to bias the lock lever 12 towards a third state (shown in FIG. 6). This disengagement of the surfaces 22/24 is caused by housing 4 abutting with the extending portion 18 of the lock lever 12.

The lock lever 12 and connector 8 are connected to one another by means of a pin 28 which extends through into the connector 8 and lock lever 12. The lock lever 12 further comprises a locking washer 30 attached to the pin 28.

The second housing 4 further comprises a guideway 32 on which a first end 34 of the connector 8 is mounted, and a second spring 36 mounted on the guideway 32, that biases the second housing 4 away from the first position shown in FIGS. 1 and 2 towards a second position shown in FIG. 4.

The connector 8 and lock lever 12 are mounted to be moveable pivotably about pin 26. However, the latch 14 prevents movement of the lock lever 12 when the second housing 4 is in the position shown in FIG. 2. As can be seen particularly in FIG. 3, the portion 18 is shaped such that there is a small gap between the portion 18 and the housing surface 20 when the lock mechanism is in the position shown in FIGS. 2 and 3. In the embodiment shown in the attached figures, the lock lever 12 will be in contact with the latch 14 as long as there is at least a small gap between the portion 18 and the housing surface 20.

In order to open the device 6, the second housing 4 must be moved to its second position as shown in FIG. 4, and from there to a third position shown in FIG. 6. In order to open the device in this way, a user merely has to push the second housing in the direction shown by arrow 200 in FIG. 2. By applying such a force, the second housing is moveable in a first mode relative to the first housing. Movement of the second housing 4 in the first mode is restricted to axial movement by the guideway 32 and the connector 8 which is locked into position during this first mode by the lock mechanism 10. The force of spring 36 will cause the second housing to continue to move towards the second position as shown in FIG. 4.

Referring now particularly to FIG. 4, the second housing 4 is shown in its second position. A first end 38 of the second housing 4 abuts with the extending portion 18 of the lock lever 12. The kinetic energy of the second housing 4 applies a force 40 to the extending portion 18 of lock lever 12 to disengage surfaces 22/24 from one another. This results in initial pivotal movement of lock mechanism 10 in the direction of arrow 42 until disengagement of the surfaces 22/24 has occurred.

The initial pivotal movement of the lock 10 in the direction of arrow 42 continues until the extending portion 18 of the lock lever 12 abuts with an under surface 19 of the second housing 4, as shown particularly in FIG. 5. In some embodiments, the end portion 38 of the second housing will continue to move axially until it abuts with end 34 of connector 8. When the lock mechanism is in its intermediate state, the spring 16 will cause the second housing 4 to pivot to a certain extent, in the direction of arrow 44.

Although FIG. 5 shows that the first and second housings 2,4 are parallel to one another, engagement of the extending portion 18 with the user surface 19 of the second housing 4 may cause the second housing 4 to be slightly non-parallel to the first housing 2.

When the lock mechanism 10 is in its second state, no further axial movement of the second housing 4 is possible, since the first end 38 of the second housing is now in abutment with the extending portion 18 of lock lever 12 preventing further axial movement. Pivotal movement of the lock lever 12 and the connector 8 causes the second housing 4 to move in a second mode. In this second mode the second housing 4 pivots about pin 26 in the direction of arrow 44 and assumes a third, tilted position shown in FIG. 6.

Once the second housing 4 has tilted in this manner, a second surface 52 of the latch 14 will be positioned to support the lock lever 12 such that the bearing surface 22 bears down on the surface 52 of the latch 14. In this position, movement of the second housing 4 from the third, tilted position to the second position is prevented, and the second housing is held in its third, tilted, position.

In this position, a user may use the device since the keyboard on the face of the first housing 2 is now fully exposed. Due to the lock lever 12 and latch 14, a user does not need to hold the second housing in the tilted position.

The user may also wish to use the electronic device with the second housing in its second, position. In order to move the second housing 4 from the third, tilted position as shown in FIG. 6, to the second, position as shown in FIG. 4, a user merely has to apply pressure to the second housing 4 in direction 54 as shown in FIG. 6. The pressure applied to the second housing causes the lock lever 12 to rotate in the direction of arrow 55. The application of further pressure causes the second housing to return to its second position, and the lock lever 12 and latch 14 to return to the position shown in FIG. 4. In this position, the force remaining in spring 36 is less than the force in spring 16. This means that the second housing 4 is locked in its second position, and a user may also use the device when the second housing is in its second position. In certain embodiments, the device may be conveniently hand-held in this configuration, for example, when making a telephone call.

In order to return the device to the closed configuration, a user pushes the second housing 4 in the direction of arrow 56 (FIG. 4), to return the electronic device to its closed configuration, as shown in FIG. 2.

If the user wishes to again tilt the second housing relative to the first housing, the user merely has to push the second housing in the direction of arrow 60 (FIG. 4). The resulting movement of the second housing 4 releases the lock lever 12 from the latch 14 and the second housing is able to move to its third position.

The first and second housing 2, 4 may comprise various electronic components including a radiotelephone engine.

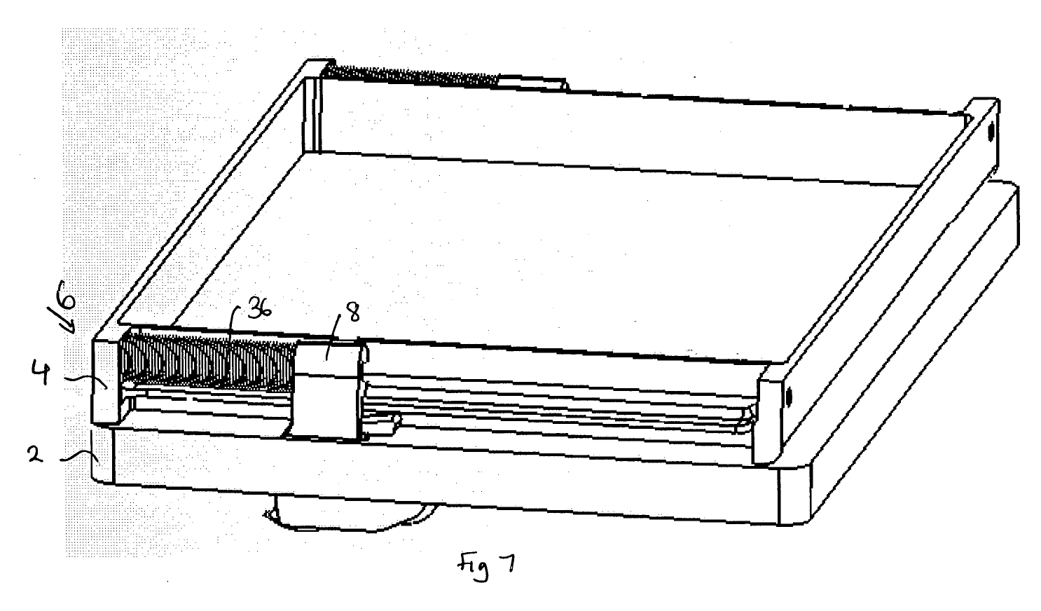

A schematic representation of an electronic device such as a mobile telephone incorporating the slide-tilt mechanism described and illustrated with reference to FIGS. 1 to 6 is shown in FIG. 7.

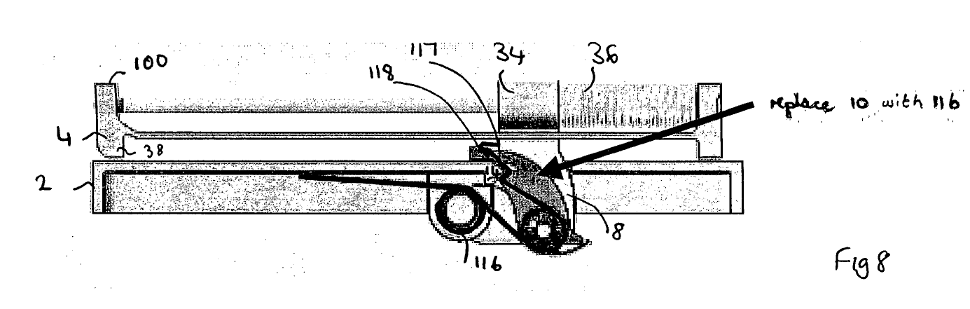

Referring now to FIG. 8, a second embodiment of a slide-tilt mechanism according to a first aspect of the present invention is designated generally by the reference numeral 100. Parts of the slide-tilt mechanism 100 that correspond to parts of the slide-tilt mechanism 6 illustrated in FIGS. 1 to 7 have been given corresponding reference numerals for ease of reference.

The slide-tilt mechanism 100 functions in a similar manner to that of slide-tilt mechanism 6, except as set out below.

The slide-tilt mechanism 100 differs from the slide-tilt mechanism 6 in that there is no lock mechanism 10 (and therefore no lock lever 12). Instead, the slide-tilt mechanism comprises a first biasing mechanism in the form of spring 116 which functions not only to bias the second part towards its third position, but also to prevent movement of the second part to its third position until the second part is in its second position (as shown in FIG. 4 in connection with slide-tilt mechanism 6). The spring 116 thus functions equivalently to not only the spring 16, but also the lock mechanism 10 forming part of the slide-tilt mechanism 6. In FIG. 8, the spring 116 is shown superimposed on the lock mechanism 10. It will be appreciated that the spring 116 replaces the lock mechanism 10 and thus the lock mechanism 10 will not actually be required in this embodiment (the lock mechanism 10 being shown in FIG. 8 for comparison)

The spring 116 is able to function in this way because it is shaped to engage with the latch 14, preventing movement of the second part 4 to its third tilt position until the end 38 of the second housing abuts with spring 116. This causes disengagement of the spring 116 from the latch 14. In particular, the spring 116 comprises a latch engaging portion 117 that is shaped to engage with, and retain the latch mechanism when the second housing 4 is in the position shown in FIG. 8. The latch engaging portion 117 further comprises a portion 118 equivalent to extending portion 18 forming part of slide-tilt mechanism 6. When the second part moves from its first position as shown in FIG. 8 towards its second position (as shown in FIG. 4 with respect to the slide-tilt mechanism 6), the front end 38 of the second part 4 will abut with portion 118 of spring 116 causing disengagement of the spring 116 from the latch 14 in a similar manner to that in which the lock mechanism 10 of a slide-tilt mechanism 6 is caused to disengage from the latch 14.

One or more aspects, embodiments, and/or features from the aspects and/or embodiments in isolation and in all various combinations are within the scope of the present disclosure whether or not specifically stated in isolation or that combination. Corresponding means for performing the functions described herein are also within the present disclosure. Methods for assembling the slide-tilt mechanism and (e.g. electronic) apparatus comprising the slide-tilt mechanism are also within the scope of the present invention.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus comprising a first part and a second part, the first part being connected to the second part such that in a first mode, the second part is axially slideable relative to the first part between a first position and a second position, and in a second mode the second part is moveable relative to the first part between the second position and a third, tilted position, the slide-tilt mechanism further comprising a first biasing mechanism configured to bias the second part from the second position towards the third tilted position.

2. The apparatus according to claim 1 wherein the first and second parts are configured to be substantially parallel to one another in the first mode.

3. The apparatus according to claim 1 further comprising a second bias mechanism for biasing the second part away from the first position towards the second position.

4. The apparatus according to claim 1 further comprising a lock mechanism, wherein the lock mechanism has a first state configured to lock the second part to be moveable only in the first mode, and a second state configured to allow the second part to be moveable only in the second mode.

5. The apparatus according to claim 4 wherein the lock mechanism is configured to be moveable between the first and second states only when the second part is in the second position.

6. The apparatus according to claim 4 further comprising a connector for connecting the first part to the second part, which connector is operatively connected to the lock mechanism.

7. The apparatus according to claim 6 wherein the second part and the connector are configured to be each pivotally moveable relative to the first part when the lock mechanism is in its second state.

8. The apparatus according to claim 6 wherein the connector has a first end portion connected to the second part, and an opposite, second end portion pivotally connected to the first part.

9. The apparatus according to claim 4 wherein the lock mechanism is configured to comprise a third state in which the second part is held in the third position.

10. The apparatus according to claim 4 wherein the first biasing mechanism comprises a resilient member operatively connected to the lock mechanism.

11. The apparatus according to claim 1 wherein the first biasing mechanism comprises a first spring mounted on a pin formed in the first part.

12. The apparatus according to claim 4 wherein the first biasing mechanism comprises a first spring mounted on a pin formed in the first part.

13. The apparatus according to claim 12 wherein the lock mechanism is pivotable about the pin.

14. The apparatus according to claim 4, wherein the lock mechanism comprises a lock lever, and a latch configured to be engageable with the lock lever to hold the lock in a first lock position associated with the first mode.

15. The apparatus according to claim 14 wherein the latch is configured to be engageable with the lock lever in a second lock position to hold the second part in its third tilted position.

16. The apparatus according to claim 14 wherein the latch is configured to be engageable with the lock lever in a first lock position to hold the second part in its second position.

17. An electronic device having a first housing and a second housing, and further comprising the apparatus according to claim 1.

18. The electronic device according to claim 17 wherein the first housing comprises the first part of the apparatus, and the second housing comprises the second part of the apparatus.

19. The electronic device according to claim 17 wherein the first housing comprises one or more user input interfaces, one or more of which are substantially covered in the first position and exposed in the second and third positions, and the second housing comprises one or more user output interfaces one or more of which are tilted towards a user in the third position.

20. An apparatus comprising a first part and a second part, the first part being connected to the second part such that in a first mode, the second part is axially slideable relative to the first part between a first position and a second position, and in a second mode the second part is moveable relative to the first part between the second position and a third, tilted position, and means for biasing the second part from the second position towards the third tilted position.

21. A method of assembling a slide-tilt mechanism, the mechanism comprising a first part and a second part, the method comprising assembling the first part to be connected to the second part such that in a first mode, the second part is axially slideable relative to the first part between a first position and a second position, and in a second mode the second part is moveable relative to the first part between the second position and a third, tilted position, and providing a first biasing mechanism to bias the second part from the second position towards the third tilted position.

22. (canceled)

23. (canceled)
